(19) United States
(12) Patent Application Publication
(10) Pub. No.: US 2026/0339511 A1
(43) Pub. Date: Oct. 29, 2026

(54) SEGREGATING DATA BASED ON RETENTION POLICY FOR EFFICIENT GARBAGE COLLECTION

(71) Applicant: Dell Products L.P., Round Rock, TX (US)

(72) Inventors: Kalyan C Gunda, Shrewsbury, MA (US); Mikhail Borisov, Dublin (IE)

(21) Appl. No.: 19/187,019

(22) Filed: Apr. 23, 2025

(51) Int. Cl. G06F 3/06

(52) U.S. Cl. CPC G06F 3/0608; G06F 3/0647; G06F 3/067

(57) ABSTRACT

Segregating data based on retention policies for efficient garbage collection is presented. An example method can comprise receiving from cloud storage equipment a group of user identity generated objects associated with one or more metadata attributes, based on the one or more metadata attributes, determining a first object of the group of user identity generated objects and a second object of the group of user identity generated objects, a collection of packing objects to be included into a storage chunk of a defined chunk size, packing the collection of packing objects into the storage chunk, creating storage chunk metadata attributes, associating the storage chunk metadata attributes with the storage chunk of the defined chunk size, and transferring the storage chunk and the storage chunk metadata attributes to the cloud storage equipment.

### BACKGROUND

Elastic Cloud Storage (ECS) is a scalable, distributed storage system designed to handle vast amounts of data across multiple locations while ensuring high availability, fault tolerance, and efficiency. ECS equipment/systems provide organizations with a flexible and cost-effective solution by dynamically allocating storage resources based on demand, preventing underutilization or over-provisioning. ECS equipment/systems support various storage models, including object, file, and block storage, making ECS equipment/systems suitable for diverse workloads such as big data analytics, backup and archival, and cloud-native applications.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system for segregating data based on retention policy for efficient garbage collection, in accordance with various non-limiting example embodiments.

FIG. 2 depicts a method, flow chart, or time sequence, for segregating data based on retention policy for efficient garbage collection, in accordance with various non-limiting example embodiments.

FIG. 3 illustrates a flow chart, method, or time sequence, for segregating data based on retention policy for efficient garbage collection, in accordance with various non-limiting example embodiments.

FIG. 4 illustrates another flow chart, method, or time sequence, for segregating data based on retention policy for efficient garbage collection, in accordance with various non-limiting example embodiments.

FIG. 5 illustrates an example storage object/chunk that can be used for segregating data based on retention policy for efficient garbage collection, in accordance with various example embodiments, in accordance with various non-limiting example embodiments.

FIG. 6 illustrates an example storage object/chunk that can be used for segregating data based on retention policy for efficient garbage collection, in accordance with various example embodiments, in accordance with various non-limiting example embodiments.

FIG. 7 illustrates an example storage object/chunk that can be used for segregating data based on retention policy for efficient garbage collection, in accordance with various example embodiments, in accordance with various non-limiting example embodiments.

FIG. 8 illustrates an example storage object/chunk that can be used for segregating data based on retention policy for efficient garbage collection, in accordance with various example embodiments, in accordance with various non-limiting example embodiments.

FIG. 9 illustrates an example storage object/chunk that can be used for segregating data based on retention policy for efficient garbage collection, in accordance with various example embodiments, in accordance with various non-limiting example embodiments.

FIG. 10 illustrates an example storage object/chunk that can be used for segregating data based on retention policy for efficient garbage collection, in accordance with various example embodiments, in accordance with various non-limiting example embodiments.

FIG. 11 illustrates a cloud storage system, such as an elastic cloud storage (ECS) system, in accordance with various non-limiting example embodiments.

FIG. 12 illustrates a block diagram representing an illustrative non-limiting computing system or operating environment in which one or more aspects of various non-limiting embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

By way of further background regarding ECS and related infrastructure, by leveraging erasure coding (EC), ECS equipment enhances data durability by distributing data chunks and associated parity chunks across multiple nodes (e.g., storage equipment), enabling recovery even in cases of hardware failures. With built-in support for multi-tenancy (e.g. storage management functionalities and facilities that aid corporate business entities, large and small, to develop applications faster and more efficiently, by enabling groups of users to both share the resources of a centralized storage architecture and customize their storage environments without affecting other groups of users), automated data tiering (e.g., storage management strategies that automatically move data between different types of storage based on data usage, performance needs, and cost-efficiency—ensuring that frequently accessed (hot) data is stored on high-performance storage while infrequently accessed (cold) data is moved to lower-cost, high-capacity storage), and integration with cloud services, ECS equipment empowers enterprises to manage and scale their storage infrastructure seamlessly while ensuring data security and compliance.

Object storage equipment is a fundamental technology behind modern cloud computing, enabling businesses to store and retrieve massive datasets efficiently and reliably. Object storage equipment implements storage architecture(s) that manage and manipulate data as objects rather than traditional file or block storage. Generally, each object associated with object storage equipment can include: data (e.g., actual file(s) and/or data being stored); metadata (e.g., information regarding the data, such as permissions, creation date, and/or custom attributes); and unique identifier addresses that allow a system to identify, locate, access, and/or retrieve the object.

Object storage equipment is typically designed for virtually unlimited storage, making object storage ideal for cloud-based and large-scale applications. Object storage equipment further allows for detailed tagging and classification of objects for easy retrieval and organization. Additionally, object storage systems ensure durability and redundancy by distributing the data across multiple locations, thereby ensuring protection again failures. Further, unlike typical file systems, objects in object storage equipment can be stored in a flat namespace, making retrieval efficient via unique identifiers.

Storage chunks or storage blocks are fundamental units of data division in modern storage systems, allowing efficient data management, redundancy, and recovery. Chunks/blocks can be categorized into different types based on their function and storage architecture. Data chunks/data blocks can contain actual user data and are the primary building blocks of stored information. Parity chunks/parity blocks can store redundancy information, and can be generated using erasure coding or RAID techniques, thereby enabling data reconstruction in cases of failures. Metadata chunks/metadata blocks can hold essential details about stored data, such as location, size, and access permissions, facilitating quick retrieval and system organization. In distributed and cloud storage systems, chunks/blocks can be spread across multiple nodes (e.g., storage equipment) to improve fault tolerance and load balancing. By categorizing storage chunks/storage blocks, systems can optimize performance, ensure data integrity, and enhance scalability, making them a crucial component of modern elastic and resilient storage architectures. Additionally, for purposes of this description, storage chunks/blocks can be append only units, and as such, data written to the storage chunks/blocks typically cannot be overwritten necessitating the user of garbage collection (GC) routines and processes to free up space.

GC is commonly used in programming languages with dynamic memory allocation, such as Java, Python, and the like. GC identifies and removes objects that are no longer referenced by applications, freeing up memory for future use. Different GC algorithms/processes exist, including reference counting, mark-and-sweep, stop-and-copy, and generational GC, each balancing efficiency, system overhead, and pause times. In storage systems, GC can play a crucial role in managing solid-state drives (SSDs) and log-structured file systems (e.g., a type of file system that writes data sequentially in a log-like structure, optimizing write performance and reducing fragmentation—instead of modifying data in place, log-structured file systems append new writes to the end of a log and periodically clean up obsolete data through GC), wherein obsolete data must be erased before new data can be written. By automating memory and storage cleanup, GC enhances application performance, prolongs hardware lifespan, reduces the risk of crashes or slowdowns caused by excessive memory consumption, and manages and optimizes storage capacity.

In accordance with various example embodiments, a system, apparatus, or device is provided comprising: a processor; and a memory that stores executable instructions that, when executed by the processor, facilitate performance of operations. The operations can comprise: receiving a group of user identity generated objects associated with one or more metadata attributes; determining, based on the one or more metadata attribute, a first object of the group of user identity generated objects and a second object of the group of user identity generated objects, a collection of packing objects to be included into a storage chunk of a defined chunk size; packing the collection of packing objects into the storage chunk; creating storage chunk metadata attributes and associating the storage chunk metadata attributes with the storage chunk of the defined chunk size, and transferring the storage chunk and the storage chunk metadata attributes to cloud storage equipment.

Concerning the foregoing, in some embodiments, the one or more metadata attributes comprise a retention policy that can comprise one or more defined retention lock expiration dates, defined storage chunk/object versioning with lifecycle policies, and the like. In certain other embodiments the one or more metadata attributes comprise at least one of a unique identification tag associated with the first object, a creation time value associated with the first object, an object size value associated with the first object, or object type data associated with the first object data.

In some embodiments, at least one of the storage chunk metadata attributes can be a first defined retention lock expiration date, wherein the first defined retention lock expiration data can be determined based on a second defined retention expiration date that can be associated with the one or more metadata attributes associated with the first object or the second object.

In some additional embodiments, the operations can further comprise instantiating the storage chunk of a defined chunk size prior to the packing of the collection of packing objects into the storage chunk.

In other embodiments, the one or more metadata attributes can comprise a first metadata attribute and a second metadata attribute, wherein the first metadata attribute and the second metadata attribute are different retention lock date values, and wherein, prior to the packing of the collection of packing objects into the storage chunk, the operations further can comprise: instantiating, based on the first metadata attribute, a first storage chunk of the defined chunk size. instantiating, based on the second metadata attribute, a second storage chunk of the defined chunk size; based on the different retention lock date values, separating the collection of packing objects into a first collection of packing objects and a second collection of packing objects, and packing the first collection of packing objects into the first storage chunk of the defined chunk size, and packing the second collection of packing objects into the second storage chunk of the defined chunk size.

In further described embodiments, additional operations can comprise determining, based on the one or more metadata attributes, that the first object can be associated with a first defined retention lock date value and the second object can be associated with a second defined retention lock date value associated, and wherein the first defined retention lock date value and the second defined retention lock date value fall within a defined range of date values.

In accordance with further embodiments, the subject disclosure describes a method, comprising a sequence of acts that can include: fetching, from cloud storage equipment by a device comprising at least one processor, a group of user identity generated objects associated with one or more metadata attributes, based on the one or more metadata attributes, determining, by the device, a first object of the group of user identity generated objects and a second object of the group of user identity generated objects, a collection of packing objects to be included into a storage chunk of a defined chunk size, packing, by the device, the collection of packing objects into the storage chunk, creating, by the device, storage chunk metadata attributes, associating, by the device, the storage chunk metadata attributes with the storage chunk of the defined chunk size, and transferring, by the device, the storage chunk and the storage chunk metadata attributes to the cloud storage equipment.

In certain described embodiments, the one or more metadata attributes can comprise a defined retention lock expiration date. In other detailed embodiments the one or more metadata attributes comprise a unique identification tag associated with the first object, a creation time value associated with the first object, an object size value associated with the first object, or object type data associated with the first object data.

In further detailed embodiments, at least one of the storage chunk metadata attributes can be a first defined retention lock expiration date, wherein the first defined retention lock expiration date can be determined based on a second defined retention expiration date that can be associated with the one or more metadata attributes associated with the first object or the second object.

In accordance with yet further embodiments, acts can comprise instantiating, by the device, the storage chunk of a defined chunk size prior to the packing of the collection of packing objects into the storage chunk. In some embodiments, the one or more metadata attributes can comprise a first metadata attribute and a second metadata attribute, wherein the first metadata attribute and the second metadata attribute can be different retention lock date values, and wherein prior to the packing, by the device, of the collection of packing objects into the storage chunk, further acts can comprise: based on the first metadata attribute instantiating, by the device, a first storage chunk of the defined chunk size, based on the second metadata attribute, instantiating, by the device, a second storage chunk of the defined chunk size, based on the different retention lock date values, segregating, by the device, the collection of packing objects into a first collection of packing objects and a second collection of packing objects, and packing, by the device, the first collection of packing objects into the first storage chunk of the defined chunk size, and packing, by the device, the second collection of packing objects into the second storage chunk of the defined chunk size.

In some described embodiments, additional acts can comprise determining, by the device based on the one or more metadata attributes, that the first object is associated with a first defined retention lock date value and the second object is associated with a second defined retention lock date value associated, wherein the first defined retention lock date value and the second defined retention lock date value fall within a defined range of date values.

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can comprise: receiving, from cloud storage equipment, a group of user identity generated objects associated with at least one metadata attribute, based on the at least one metadata attribute, determining a first object of the group of user identity generated objects and a second object of the group of user identity generated objects, a collection of packing objects to be included into a storage chunk of a defined chunk size, packing the collection of packing objects into the storage chunk, creating storage chunk metadata attributes; associating the storage chunk metadata attributes with the storage chunk of the defined chunk size, and transferring the storage chunk and the storage chunk metadata attributes to the cloud storage equipment.

In various illustrative embodiments, the at least one metadata attribute can comprise a defined retention lock expiration date. In other example embodiments, at least one of the storage chunk metadata attributes can be a first defined retention lock expiration date, and wherein the first defined retention lock expiration date can be determined based on a second defined retention expiration date that can be associated with the at least one metadata attribute associated with the first object or the second object.

In additional example embodiments, the operations can further comprise instantiating the storage chunk of a defined chunk size prior to the packing of the collection of packing objects into the storage chunk.

In certain illustrative embodiments, the at least one metadata attribute can comprise a first metadata attribute and a second metadata attribute, wherein the first metadata attribute and the second metadata attribute can be different retention lock date values, and wherein, prior to the packing of the collection of packing objects into the storage chunk, the operations can further comprise: based on the first metadata attribute instantiating a first storage chunk of the defined chunk size, based on the second metadata attribute, instantiating a second storage chunk of the defined chunk size, based on the different retention lock date values, segregating the collection of packing objects into a first collection of packing objects and a second collection of packing objects, and packing the first collection of packing objects into the first storage chunk of the defined chunk size, and packing the second collection of packing objects into the second storage chunk of the defined chunk size.

Further, in some example embodiments, the operations can further comprise determining, based on the at least one metadata attribute, that the first object can be associated with a first defined retention lock date value and the second object can be associated with a second defined retention lock date value associated, and wherein the first defined retention lock date value and the second defined retention lock date value fall within a defined range of date values.

There is a wide range of file and object storage equipment/systems available today. Some storage equipment, such as ECS equipment can support data retention policies (e.g. locking and versioning using defined lifecycle policies). Generally, such systems can store data in special logical containers called chunks or blocks. As data gets deleted these chunks/blocks can become internally fragmented, which ultimately can require garbage collection processes to reclaim the fragmented space using copy forward garbage collection processes (e.g., processes that manage disk/memory resources by copying live objects—undeleted objects—from a first part/area of a disk/memory resource to another, generally more compact, part/area of the disk/memory resource, leaving behind the garbage (the fragmented space—space that was previously used to store now deleted chunks/blocks). Execution of copy forward garbage collection processes can be extremely resource intensive in terms of disk input/output (I/O), memory bandwidth, and central processing unit resource usage. Consequently, this disclosure detail systems and methods for avoiding the use of GC processes in cases where data expiration dates are known (e.g., predetermined, defined, definable, determinable, . . . ) in relation to object retention times.

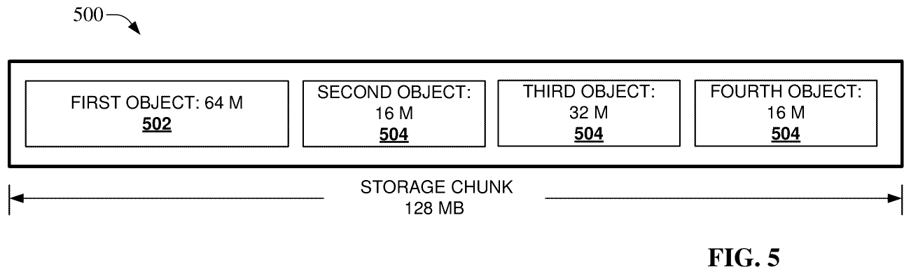

Typically, in most storage systems, objects and files can be created by end users (e.g., user identities). The objects and files generally can be written to storage equipment in the form of chunks or blocks, wherein each chunk or block can be of a fixed/defined size. In the case of ECS equipment, a chunk or block size can approximately be, and can approach about, 128 megabytes (e.g., 128 MB). Thus, when an object, of, for example 32 MB, is written by a user identity, the 32 MB object can be positioned and/or mapped to storage object/chunk along with other objects. In accordance with these embodiments, the 32 MB object can be grouped along with all other objects written to that point into a 128 MB storage object/chunk and the storage object/chunk can be written to persistence media, such hard disk media, reel-to-reel tape media, write once read many (WORM) persistence media, solid state drive (SSD) memory media, flash memories, universal serial bus (USB) implementations of storage media, and the like. An illustration of an example storage object/chunk is depicted in FIG. 5.

FIG. 5 illustrates an example storage object/chunk 500 that can be used for segregating data based on retention policy for efficient garbage collection, in accordance with various example embodiments. As depicted, storage object/chunk 500 can be sized at about 128 MB, within which, solely for purposes of illustration and exposition, can be four user identity generated objects of different sizes. The first user identity generated object 502 can be 64 MB in size, the second user identity generated object 504 can be 16 MB in size, the third user identity generated object 506 can be 32 MB in size, and the fourth user identity generated object 508 can be 16 MB in size. It will be noted that the sum of the sizes of each of the four user identity generated objects can approach approximately 128 MB. It will also be observed the described storage object/chunk 500 can comprise objects of differing and varying sizes (e.g., as depicted, the first user identity generated object 502 is represented as being 64 MB in size, the second user identity generated object 504 is represented as being 16 MB in size, the third user identity generated object 506 is represented as being 32 MB in size, and the fourth user identity generated object 508 is represented as being 16 MB in size).

Concerning the above used term “user identity generated objects,” it is to be understood that the user identity generated objects can have been generated by human user identities (e.g. social media and social networking data, photographic image data, video data and audio data, and the like, generated by a human), as well as software in execution that can have been coded by human user identities and/or artificial intelligence (AI) agents, as well as code that can have been automatically generated using one or more of data mining, AI, data analytic, and/or generative machine learning paradigms. The user identity generated objects can comprise computer executable code, data used to execute the computer executable code, ancillary data can be used to facilitate and/or effectuate execution of the computer executable code, as well any resulting data that can have been a resultant consequence of execution the computer executable code. The user identity generated objects can also comprise data associated with various computer/system generated data, such as crash dump log data, uptime log data, and the like. Further, the user identity generated object can also comprise data required for governmental compliance and reporting purposes. It should also be observed that any data stored/persisted and/or positioned within the detailed storage object can be both structured data as well as unstructured data.

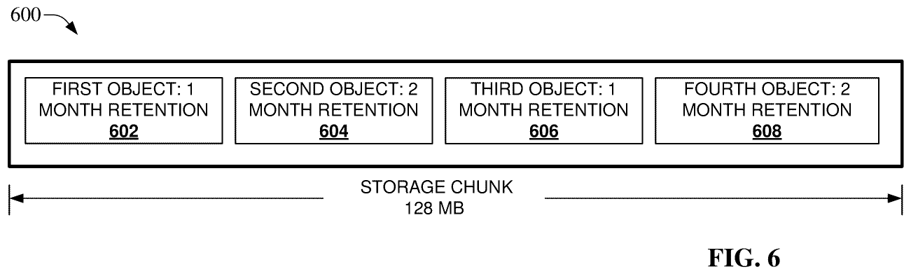

In accordance with various illustrative embodiments, FIG. 6 illustrates another example storage object/chunk 600 that can be used for segregating data based on retention policy for efficient garbage collection. In general, as user identity generated objects are deleted from storage objects/chunks (e.g., storage object/chunk 600) fragmentation within the storage object/chunk 600 can occur. Fragmentation within storage objects/chunks (e.g., storage object/chunk 600) can and will necessitate execution of GC process in terms of copy and forward routines to free up the storage object/chunk 600. Currently is no viable special handling for objects and/or files associated with defined retention policies. Hence, at the moment, object placement within storage objects/chunks (e.g., storage object/chunk 600) fails to look at defined or determinable retention lock (RL) time periods that generally can have been associated with user identity generated objects/files. Thus, at the present time, storage objects/chunks (e.g., storage object/chunk 600) can comprise user identity generated objects/files that can have associated thereto defined or undefined metadata attributes pertaining to retention periods for individual user generated objects/files included in storage object/chunk 600. As can be observed in connection with FIG. 6, and in particular with reference to storage object/chunk 600, each user object/file (e.g., first object: 1 month retention 602, second object: 2 month retention 604, third object: 1 month retention 606, and fourth object: 2 month retention 608) within storage object/chunk 600 can have been generated and/or associated with multiple different user identities (e.g., user identity 1, user identity 2, . . . ), and can also have been associated with metadata indicating different defined/determinable retention periods (e.g., 1 month extension and 2 month extension). In this illustration, while not specifically depicted, the first object 602 can have been generated by a first user, second object 604 can have been generated by a second user, third object 606 can have been generated by the first user, and fourth object 608 can have been generated by the second user.

In regard to the illustrated use of just two retention periods (e.g., 1 month retention and 2 month retention) in this description, it will be appreciated by those of ordinary skill that a diverse multiplicity of different retention periods can be employed with equal functionality and facility without departing from the ambit of this disclosure, and that the use of the two depicted retention periods are solely for ease of exposition and illustration. Similarly, generation of the data stored to first object 602, second object 604, third object 606, and fourth object 608, can have been generated by a group of diverse user identities. For instance, data stored to first object 602 can have been generated by a third user identity, second object 604 can have been generated by a fourth user identity, third object 606 can have been generated by a fifth user identity, and fourth object 608 can have been generated by a sixth user identity. Accordingly, the subject disclosure is not limited to just two user identities; contemporaneous use of the subject disclosure by a vast number of different user identities is within the contemplation of the inventors.

Turning back to FIG. 6, it will be noted that storage object/chunk 600 can comprise disparate objects associated with various user identities and with various associated defined RL duration periods. It will further be noted that the disparate objects associated with the various user identities and associated defined RL duration periods can be randomly interspersed/randomly intercalated throughout storage object/chunk 600; there does not need to be a contiguity of user generated objects arranged/ordered either by, for example, user identity and/or defined RL duration periods, but, as those of skill with appreciate, a contiguity of user generated objects based on user identity and/or defined duration period can occur, and as such will fall within the scope of this disclosure.

Further, in accordance with some various detailed embodiments, user generated objects (e.g. first object 602 can be situated at a head end of storage object chunk 600 and fourth object 608) can be positioned/packed within storage object/chunk 600 in a first-in ordering, wherein first object 602 can be situated at a head end of storage object chunk 600 while fourth object 608 can be positioned at a tail end of storage object/chunk 600.

In accordance with other embodiments, user generated objects can be dispersed throughout storage object/chunk in a random order. In certain embodiments the organization of the layout of storage object/chunk 600 can be maintained by storage object/chunk 600 metadata. In other embodiments the arrangement of where disparate user generated objects associated with defined user identities can be maintained by metadata associated with the user generated objects. For instance, in the illustration provided by FIG. 6, first object 602 and third object 606 can comprise data that can have been generated by a first user identity, and as such metadata associated with each of first object 602 and/or third object 606 can reflect this reality. Similar mapping relationships between objects generated by diverse user identities can be persisted as metadata attributes associated with metadata associated with each of the various objects (e.g., first object 602, second object 604, third object 606, and fourth object 808). In accordance with other embodiments set forth in this disclosure, metadata and metadata attributes can similarly be associated with storage object/chunk 600. As will be appreciated by those having ordinary skill in the art, metadata can represent a panoply of different attributes, such as uniquely generated identifiers associated with each of the various objects (e.g., first object 602, second object 604, third object 606, and fourth object 808), as well as various storage objects/chunks (e.g., storage object/chunk 600).

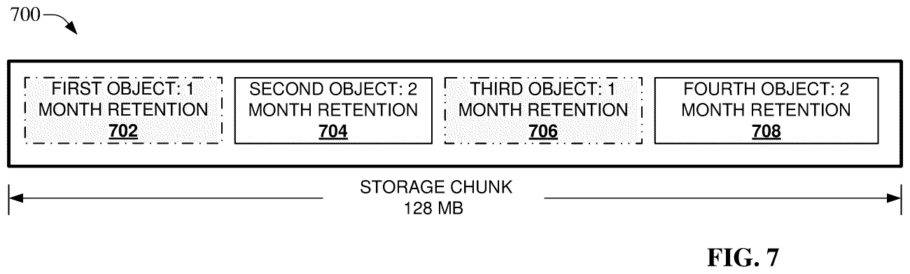

In the instance illustrated in FIG. 6, storage object/chunk 600, for example, can be associated with metadata attributes representing a RL duration of one month and two months, since storage object/chunk 600 comprises user generated objects/files that have been associated the RL duration periods of one month and/or two months. At the expiration of the defined one month RL duration period, objects scheduled to expire at the end of the defined one month RL duration period (e.g., first object 602 and third object 606) can be eligible for deletion by background lifecycle policy processes (e.g., executing GC processes). Once objects that are eligible for deletion have been removed from the storage object/chunk (e.g., storage object/chunk 600) the storage object/chunk depiction can transition to the storage object/chunk representation illustrated in FIG. 7 (e.g., storage object/chunk 700).

FIG. 7 illustrates another example storage object/chunk 700 that can be used for segregating data based on retention policy for efficient garbage collection, in accordance with various illustrative embodiments. Storage object/chunk 700 can be a representation of storage object/chunk 600 as a consequence of the removal of eligible objects from storage object/chunk 600. As illustrated in FIG. 7, it will noted that user identity generated first object: 1 month retention 702 and user identity generated third object: 1 month retention 706 are respectively outlined in dotted lines and shaded to indicate that these user identity generated objects are no longer associated with storage object/chunk 700; they can have been removed, for example, via GC processes in execution. The removal of the user identity generated first object: 1 month retention 702 and the user identity generated third object: 1 month retention 706 will have left voids (e.g., free space respectively left vacant by the deletion/removal of user identity generated first object: 1 month retention 702 and user identity generated third object: 1 month retention 706) within storage object/chunk 700, leaving just user identity generated second object: 2 month retention 704 and user identity generated fourth object: 2 month retention 708 occupying storage object/chunk 700. On observation of storage object/chunk 700 it will be noted that the removal/deletion of user identity generated first object: 1 month retention 702 and user identity generated third object: 1 month retention 706 from storage object/chunk 700 has caused storage object/chunk 700 to become fragmented since the free space left empty by the removal/deletion of user identity generated first object: 1 month retention 702 and user identity generated third object: 1 month retention 706 is not contiguous (e.g., there is a void/free space where user identity generated first object: 1 month retention 702 once was and a further void/free space where user identity generated third object: 1 month retention 706 once was).

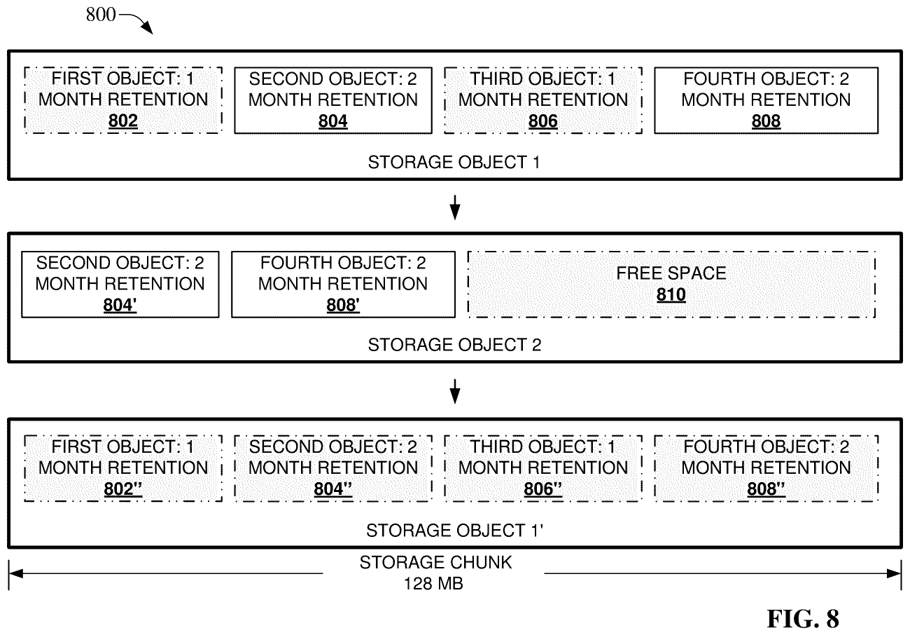

In order to rectify/remedy the resultant fragmentation, and as illustrated in FIG. 8 a visualized sequence of events 800 can occur. FIG. 8 provides illustration of first storage object 1 (e.g., storage object/chunk 700) with the free space/void situation as illustrated and detailed above in connection with FIG. 7. Since first storage object 1 has been fragmented by the deletion/removal of user identity generated first object: 1 month retention 802 and user identity generated third object: 1 month retention 806, a second storage object (e.g., storage object 2) will need to be instantiated so that user identity generated second object: 2 month retention 804 and user identity generated fourth object: 2 month retention 808 can be transferred into the newly instantiated storage object (e.g., storage object 2). By moving user identity generated second object: 2 month retention 804 and user identity generated fourth object: 2 month retention 808 (now labeled user identity generated second object: 2 month retention 804′ and user identity generated fourth object: 2 month retention 808′) into the instantiated storage object (e.g., storage object 2) the remainder of the instantiated storage object (e.g., storage object 2) can be contiguous free space 810. Further, by transferring user identity generated second object: 2 month retention 804 and user identity generated fourth object: 2 month retention 808 to become user identity generated second object: 2 month retention 804′ and user identity generated fourth object: 2 month retention 808′, the original storage object/chunk (e.g., storage object 1) can be rendered empty of content as depicted as storage object 1′, wherein user identity generated first object 802′, user identity generated second object 804′, user identity generated third object 806′, and user identity generated fourth object 808′ have been depicted as being empty with dotted lines and shading.

In order to avoid the foregoing fragmentation issues and further to avoid elaborate GC requirements necessitated by copying and forwarding data and in accordance with various embodiments, this application details and describes storing user identity generated objects associated with common metadata attributes in the same storage object/chunk. For instance, user identity generated objects can be stored to a storage object/chunk, for example, based on RL duration period (e.g., half a day (e.g., 12 hours), one day (e.g., 24 hours), five business days, five consecutive days, seven days (e.g., one week), a fortnight (e.g., two weeks or 14 days), one month, . . . ). Thus, as user identity generated objects are written these user identity generated objects can be analyzed and saved to storage objects/chunks with the same and/or similar RL duration time frames. Thus, storage objects/chunks comprising, in their entirety, user identity generated object with the same and/or similar RL time durations can result in fuller chunks (e.g., all the user identity generated objects are generally associated metadata attributes representing the same and/or similar RL time durations), and there is less need to perform resource intensive copy and forward GC processes.

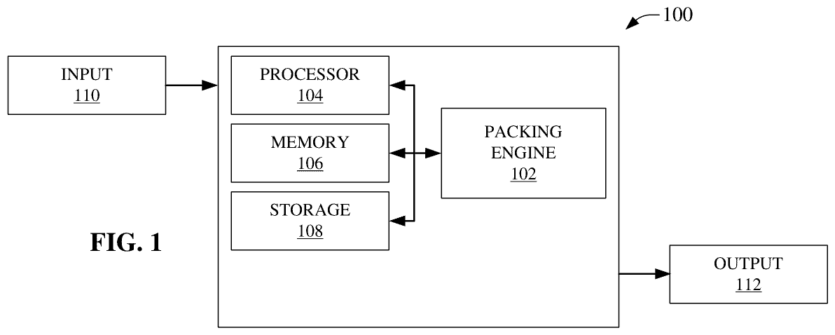

FIG. 1 depicts a system 100 for segregating data based on retention policy for efficient garbage collection (GC), in accordance with various non-limiting example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IoT) equipment, multimedia players, and the like.

System 100 can comprise packing engine 102 that can be in operative communication with processor 104, memory 106, and storage 108. Packing engine 102 can be in communication with processor 104 for facilitating operation of computer-executable instructions or machine-executable instructions and/or components by packing engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by packing engine 102 to produce one or more useful, concrete, and tangible results, and/or transform one or more articles to different states or things. Further, system 100 can also generate and output the useful, concrete, and tangible result and/or the transformed one or more articles as output 112.

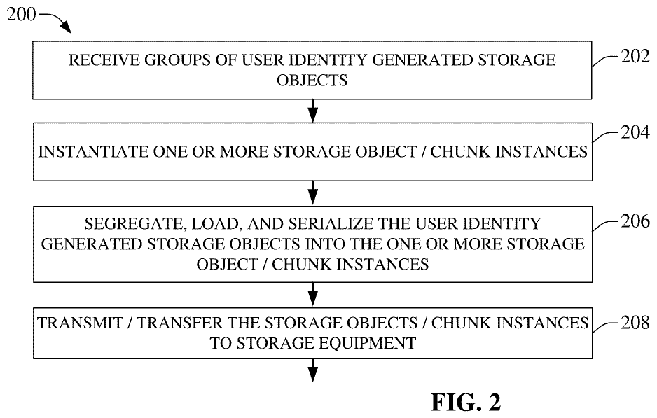

Packing engine 102 in relation to method 200, as illustrated in FIG. 2—a method for segregating data based on retention policy for efficient garbage collection, in various described example embodiments, in response to receiving, as input 110, groups of user identity generated storage objects, at act 202, can analyze each user identity generated storage object in the groups of user identity generated storage objects to determined whether or not the user identity generated storage object has associated with it metadata, and whether or not the associated metadata comprises metadata attributes indicative of RL time horizons concerning how long each user identity generated storage object is to be persisted to storage equipment.

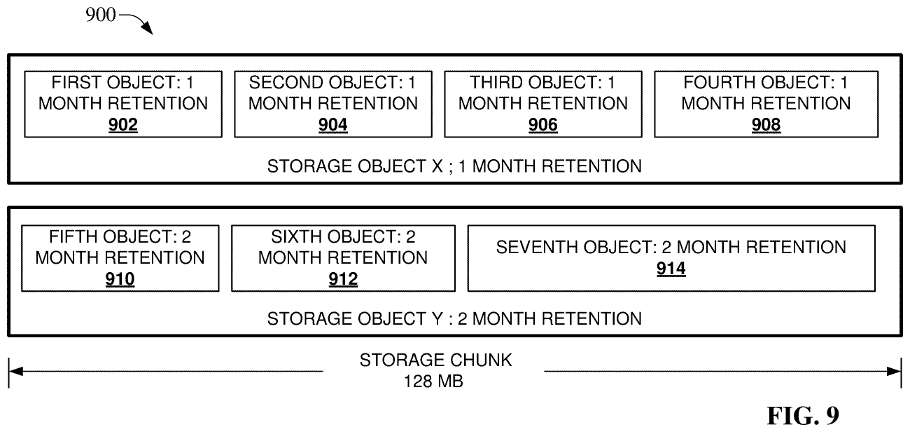

Based on the metadata attributes associated with the in flowing groups of user identity generated storage objects, packing engine 102, at act 204, can instantiate one or more storage objects/chunks (see FIG. 9 wherein two storage objects storage object X and storage object Y have been instantiated). During the instantiation of the one or more storage objects/chunks, packing engine 102, also at act 204, can associate storage object/chunk metadata attribute data indicative of respective RL time durations. For example, as depicted in FIG. 9, storage object X, at act 202, can have been associated with a RL time duration of one month (e.g., 1 month retention). Similarly, packing engine 102, at act 204, can have storage object/chunk metadata associated with storage object Y indicating a RL time period of two months.

Packing engine 102, at act 206, can then segregate and load/serialize each user identity generated storage object in the groups of incoming user identity generated storage objects to the appropriate instantiated one or more storage objects/chunks. For example, as illustrated in FIG. 9, storage object X: 1 month retention has been loaded with user identity generate storage objects (e.g., first object: 1 month retention 902, second object: 1 month retention 904, third object: 1 month retention 906, and fourth object: 1 month retention 908). Similarly, storage object Y: 2 month retention has been loaded with user identity generate storage objects (e.g., fifth object: 2 month retention 9010, sixth object: 2 month retention 912, seventh object: 2 month retention 914, and eighth object: 2 month retention 916).

Once each storage object/chunk has been serialized and/or loaded with user identity generated storage objects, filtered/sorted/segregated based on user identity generated storage object metadata attribute data (e.g., RL time duration), packing engine 102, at act 208, can transfer each storage object/chunk to storage equipment, as output 112.

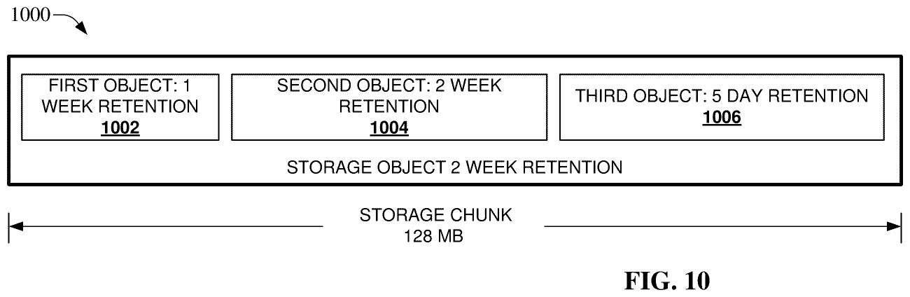

In some embodiments, where user identities specify RL time durations associated with user identity generated storage objects in more granular fashions, RL time durations can vary significantly particularly when a user identity specifies the RL time duration in terms of days, months to years—a spread of greatly varying retention times—that can greatly impact the quantum of storage objects/chunks that need to be kept open at the same time. To address this possibility, in certain example embodiments, packing engine 102 can utilize RL time duration based extent boundaries. For example, where user identity generated storage objects are associated with metadata specifying RL periods less than a seven day week, packing engine 102 can instantiate a storage object/chunk for one week seven day period, wherein packing engine 102 can load user identity generated storage objects that can have been tagged with metadata specifying RL time periods related, for instance, to a seven day week, a defined few days within the seven day week, and the like. This feature of the subject disclosure is illustrated in FIG. 10, wherein storage object/chunk 1000 (e.g., storage object 2 week retention) comprises user identity generated storage objects associated with metadata attributes indicative of a one week retention period (e.g. first object: 1 week retention 1002), a two week retention period (e.g., second object: 2 week retention 1004), and a five day retention period (e.g., third object: 5 day retention 1006).

As has been noted earlier, instantiated storage objects/chunks can be associated, at the storage object/chunk level, with storage object/chunk metadata comprising groups of metadata attributes, such as pseudorandom generated identifiers; storage object/chunk size indicators (e.g., 128 MB); appropriate RL time periods, and the like. Accordingly, GC processes can also be optimized/adapted to look at the groups of metadata attributes associated with instantiated storage objects/chunks to determine whether or not to skip the instantiated storage objects/chunks. Only if the RL time period has been set as a metadata attribute appended to the instantiated storage object/chunk at the instantiated storage object/chunk level, and if the set RL time period has expired, will packing engine 102 further peruse the metadata attributes associated with the user identity generated storage objects at the individual user identity generated storage object level.

While the subject disclosure assumes that user identity generated storage objects will ultimately be deleted at the expiration of the RL time period, in instances where deletion of the user identity generated storage objects is not a resultant consequence of the expiration of the RL time period, there can be value in storing user identity generated storage objects together in instantiated storage objects/chunks with similar retention times as unexpired storage objects/chunks can be skipped and lifecycle policy processes (e.g., GC processes) can execute more rapidly at an instantiated storage object/chunk level.

It should be observed, for ease of exposition, this description has been detailed in terms of RL time duration attribute data; other metadata attributes can also be used, with equal facility and/or functionality, to filter/sort/segregate user identity generated storage objects into one or more instantiated storage objects/chunks (e.g., storage object X and storage object Y, as depicted in FIG. 9).

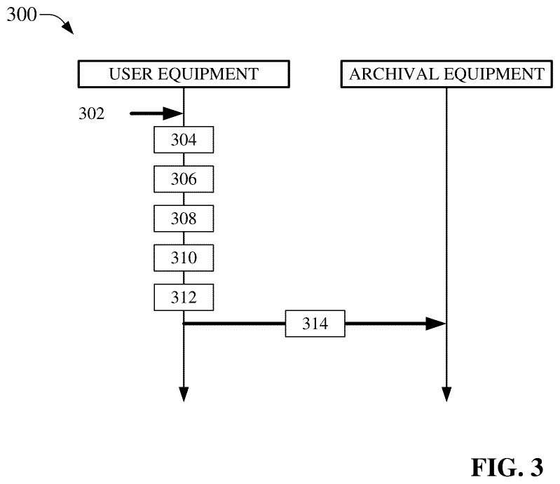

FIG. 3 illustrates a sequence flow chart 300 for segregating data based on retention policy for efficient GC, in accordance with various non-limiting example embodiments. Sequence flow chart 300 can commence at act 302 wherein packing engine 102 can receive, as input 110, groups of user identity generated storage objects. In response to receiving the groups of user identity generated storage objects, packing engine 102, at act 304, can perform an analysis on each user identity generated storage object included in the groups of user identity generated storage objects, and at act 306 can determine whether or not the user identity generated storage object has been associated with user identity generate storage object metadata representing metadata attributes indicative of defined RL time durations concerning how long each user identity generated storage object is to be persisted to storage equipment/archival equipment. Packing engine 102, at act 308, based on determining that the user identity generated storage object has been associated with metadata attributes indicative of RL time durations concerning how long each user identity generated storage object is to be retained by storage equipment/archival equipment, can instantiate one or more storage objects/chunks based on one or more metadata attributes associated with the user identity generated storage object. At act 310, packing engine 102 can associate to each of the one or more instantiated storage objects/chunks storage object/chunk metadata representing groups of storage object/chunk metadata attributes. In accordance with certain embodiments, the groups of storage object/chunk metadata attributes can be sourced from user identity storage object metadata attributes, such as user identity storage object metadata attributes associated with defined RL time durations. At act 312, based on the user identity storage object metadata attributes and/or the storage object/chunk metadata representing groups of storage object/chunk metadata attributes, packing engine 102 can sort/segregate and load/pack each user identity generated storage object into an appropriate storage objects/chunks. At act 314, packing engine 102 can transfer each storage object/chunk instance to storage equipment/archival equipment.

In regard to the sequence flow chart 300, additional actions that can be performed by packing engine 102, can include, having transferred each storage object/chunk instance to storage equipment/archival equipment at act 314 packing engine 102, can wait for an acknowledgement representing acknowledgment data to be returned from storage equipment/archival equipment. In instances where the acknowledgement data is not returned within a defined period of time, packing engine 102 can attempt to resend the storage object/chunk instance to the storage equipment/archival equipment after a defined or definable back off period. In some embodiments, the defined or definable back off period can be generated using one or more pseudorandom number generator processes in execution, wherein the back off period identified by the one or more pseudorandom number generator process can, for example, be in a range of single digit nanoseconds to approximately multiple digit minutes.

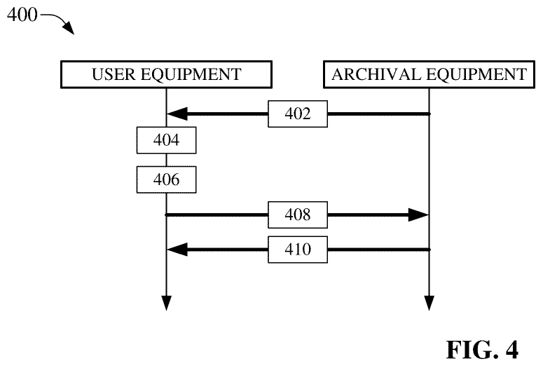

FIG. 4 illustrated a time sequence flow 400 for segregating data based on retention policy for efficient GC, in accordance with various non-limiting example embodiments. Time sequence flow 400 can commence at act 402 wherein packing engine 102 can fetch from storage equipment/archival equipment, groups of user identity generated storage objects. In response to receiving the groups of user identity generated storage objects, packing engine 102, at act 404, can perform an analysis on each user identity generated storage object included in the groups of user identity generated storage objects. Further, and at act 404 packing engine 102 can determine whether or not the user identity generated storage object has been associated with user identity generate storage object metadata representing metadata attributes indicative of defined RL time durations concerning how long each user identity generated storage object is to be persisted to storage equipment/archival equipment. Packing engine 102, at act 406, based on determining that the user identity generated storage object has been associated with metadata attributes indicative of RL time durations concerning how long each user identity generated storage object is to be retained by storage equipment/archival equipment, can instantiate one or more storage objects/chunks based on one or more metadata attributes associated with the user identity generated storage object. Also at act 406, packing engine 102 can associate to each of the one or more instantiated storage objects/chunks storage object/chunk metadata representing groups of storage object/chunk metadata attributes. In accordance with certain embodiments, the groups of storage object/chunk metadata attributes can be sourced from user identity storage object metadata attributes, such as user identity storage object metadata attributes associated with defined RL time durations. Further at act 406, based on the user identity storage object metadata attributes and/or the storage object/chunk metadata representing groups of storage object/chunk metadata attributes, packing engine 102 can sort/segregate and load/pack each user identity generated storage object into an appropriate storage objects/chunks. At act 408, packing engine 102 can transfer each storage object/chunk instance to storage equipment/archival equipment.

Further, at act 410 packing engine 102, having transferred each storage object/chunk instance to storage equipment/archival equipment at act 408, can wait for an acknowledgement representing acknowledgment data to be returned from storage equipment/archival equipment. In instances where the acknowledgement data is not returned within a defined period of time, packing engine 102 can attempt to resend the storage object/chunk instance to the storage equipment/archival equipment after a defined or definable back off period. In some embodiments, the defined or definable back off period can be generated using one or more pseudorandom number generator processes in execution, wherein the back off period identified by the one or more pseudorandom number generator process can, for example, be in a range of single digit nanoseconds to approximately multiple digit minutes.

It will be appreciated by those skilled in the art that the preceding examples and embodiments are exemplary and not limited to the scope of the present disclosure. It shall also be noted that elements of any claims may be arranged differently including having multiple dependencies, configurations, and combinations.

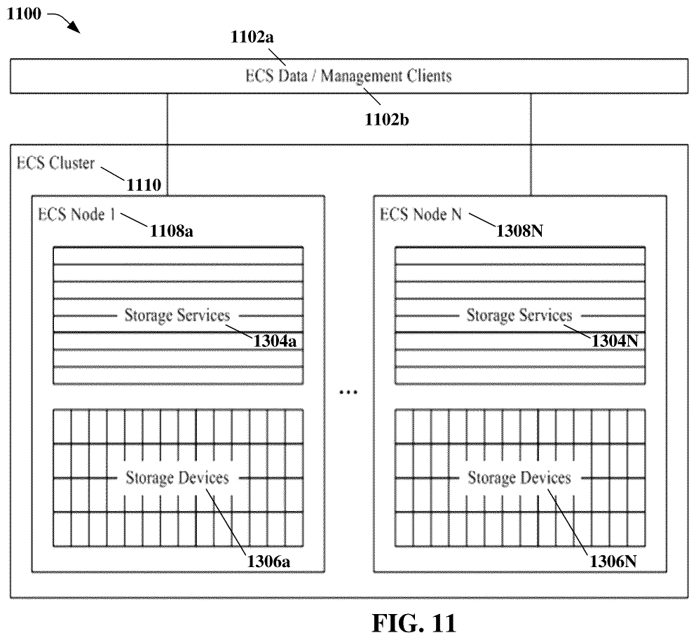

In the following, FIG. 11 describes an example non-limiting cloud storage system in the non-limiting context of an ECS storage system, but for the avoidance of doubt, the subject embodiments can apply to any storage platform. For instance, in this regard, FIG. 11 illustrates an ECS storage system 1100 comprising a cloud-based object storage appliance in which corresponding storage control software comprising, e.g., ECS data client(s) 1102a, ECS management client(s) 1102b, storage service(s) 1104a . . . 1104N, etc. and storage devices 1106a . . . 1106N (e.g., storage media, such as physical magnetic disk media, etc. of respective ECS nodes of ECS cluster 1110) are combined as an integrated system with no access to the storage media other than through the ECS storage system 1100.

In this regard, ECS cluster 1110 comprises multiple nodes 1108a . . . 1108N, storage nodes, ECS nodes, etc. Each node is associated with storage devices 1106a . . . 1106N, e.g., hard drives, physical disk drives, storage media, etc. In embodiment(s), ECS node 1108a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 1100 can be an append-only virtual storage platform that protects content from being erased or overwritten for a specified retention period. In particular, the ECS storage system 1100 does not employ traditional data protection schemes like mirroring or parity protection. Instead, the ECS storage system 1100 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 1100 can support storage, manipulation, and/or analysis of unstructured data on a massive scale on commodity hardware. As an example, the ECS storage system 1100 can support mobile, cloud, big data, and/or social networking applications. In another example, the ECS storage system 1100 can be deployed as a turnkey storage appliance, or as a software product that can be installed on a set of qualified commodity servers and disks, e.g., within a node, data storage node, etc. of a cluster, data storage cluster, etc. In this regard, the ECS storage system 1100 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1222, disk storage 1224, and/or memory storage 1246, further description of which is below. For instance, nonvolatile memory can be included in read only memory (ROM), programmable ROM (PROM), electrically programmable ROM (EPROM), electrically erasable ROM (EEPROM), or flash memory. Volatile memory 1220 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

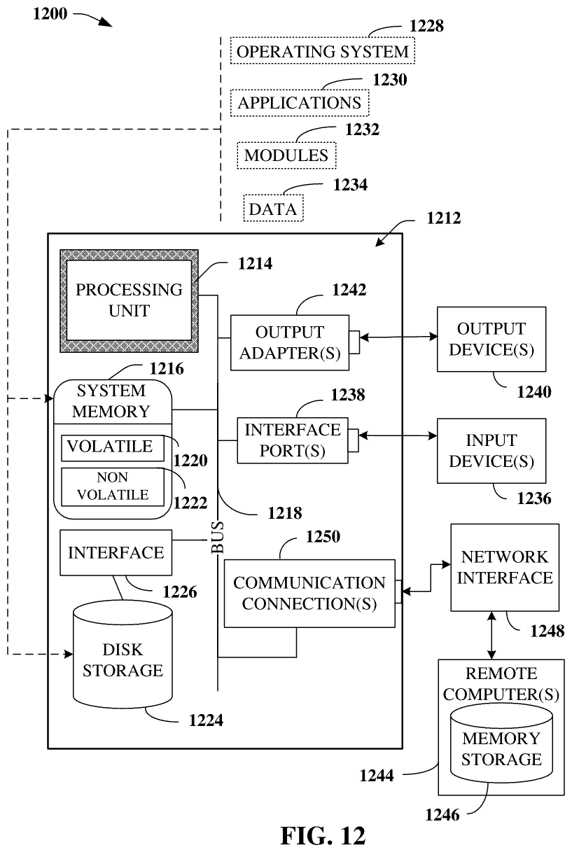

In order to provide a context for the various aspects of the disclosed subject matter, FIG. 12, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

FIG. 12, a block diagram of a computing system 1200, e.g., system 700, operable to execute the disclosed example embodiments, is illustrated, in accordance with an embodiment. Computer 1212 comprises a processing unit 1214, a system memory 1216, and a system bus 1218. System bus 1218 couples system components comprising, but not limited to, system memory 1216 to processing unit 1214. Processing unit 1214 can be any of various available processors. Dual microprocessors and other multiprocessor architectures also can be employed as processing unit 1214.

System bus 1218 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1216 comprises volatile memory 1220 and nonvolatile memory 1222. A basic input/output system (BIOS), containing routines to transfer information between elements within computer 1212, such as during start-up, can be stored in nonvolatile memory 1222. By way of illustration, and not limitation, nonvolatile memory 1222 can comprise ROM, PROM, EPROM, EEPROM, or flash memory. Volatile memory 1220 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also comprises removable/non-removable, volatile/non-volatile computer storage media. FIG. 12 illustrates, for example, disk storage 1224. Disk storage 1224 comprises, but is not limited to, devices like a magnetic disk drive, floppy disk drive, tape drive, Jaz drive, Zip drive, LS-100 drive, flash memory card, or memory stick. In addition, disk storage 1224 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to system bus 1218, a removable or non-removable interface is typically used, such as interface 1226.

It is to be appreciated that FIG. 12 describes software that acts as an intermediary between users and computer resources described in suitable operating environment 1200. Such software comprises an operating system 1228. Operating system 1228, which can be stored on disk storage 1224, acts to control and allocate resources of computer system 1212. System applications 1230 take advantage of the management of resources by operating system 1228 through program modules 1232 and program data 1234 stored either in system memory 1216 or on disk storage 1224. It is to be appreciated that the disclosed subject matter can be implemented with various operating systems or combinations of operating systems.

A user can enter commands or information into computer 1212 through input device(s) 1236. Input devices 1236 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1214 through system bus 1218 via interface port(s) 1238. Interface port(s) 1238 comprise, for example, a serial port, a parallel port, a game port, a universal serial bus (USB), a wireless based port, e.g., Wi-Fi, Bluetooth, etc. Output device(s) 1240 use some of the same type of ports as input device(s) 1236.

Thus, for example, a USB port can be used to provide input to computer 1212 and to output information from computer 1212 to an output device 1240. Output adapter 1242 is provided to illustrate that there are some output devices 1240, like display devices, light projection devices, monitors, speakers, and printers, among other output devices 1240, which use special adapters. Output adapters 1242 comprise, by way of illustration and not limitation, video and sound devices, cards, etc. that provide means of connection between output device 1240 and system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. Remote computer(s) 1244 can be a personal computer, a server, a router, a network PC, a workstation, a microprocessor based appliance, a peer device, or other common network node and the like, and typically comprises many or all of the elements described relative to computer 1212.

For purposes of brevity, only a memory storage device 1246 is illustrated with remote computer(s) 1244. Remote computer(s) 1244 is logically connected to computer 1212 through a network interface 1248 and then physically and/or wirelessly connected via communication connection 1250. Network interface 1248 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1250 refer(s) to hardware/software employed to connect network interface 1248 to bus 1218. While communication connection 1250 is shown for illustrative clarity inside computer 1212, it can also be external to computer 1212. The hardware/software for connection to network interface 1248 can comprise, for example, internal and external technologies such as modems, comprising regular telephone grade modems, cable modems and DSL modems, wireless modems, ISDN adapters, and Ethernet cards.

The computer 1212 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1212 can connect to other devices/networks by way of antenna, port, network interface adaptor, wireless access point, modem, and/or the like.

The computer 1212 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at a 10 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. Storage equipment, comprising:
at least one processor; and
at least one memory that stores executable instructions that, when executed by the at least one processor, facilitate performance of operations, comprising:
receiving a group of user identity generated objects associated with one or more metadata attributes;
determining, based on the one or more metadata attribute, a first object of the group of user identity generated objects and a second object of the group of user identity generated objects, a collection of packing objects to be included into a storage chunk of a defined chunk size;
packing the collection of packing objects into the storage chunk;
creating storage chunk metadata attributes and associating the storage chunk metadata attributes with the storage chunk of the defined chunk size; and
transferring the storage chunk and the storage chunk metadata attributes to cloud storage equipment.

2. The storage equipment of claim 1, wherein the one or more metadata attributes comprise a defined date associated with a retention policy.

3. The storage equipment of claim 1, wherein the one or more metadata attributes comprise at least one of a unique identification tag associated with the first object, a creation time value associated with the first object, an object size value associated with the first object, or object type data associated with the first object data.

4. The storage equipment of claim 1, wherein at least one of the storage chunk metadata attributes is a first defined date associated with a retention policy, wherein the first defined retention lock expiration data is determined based on a second defined retention expiration date that is associated with the one or more metadata attributes associated with the first object or the second object.

5. The storage equipment of claim 1, the operations further comprising instantiating the storage chunk of a defined chunk size prior to the packing of the collection of packing objects into the storage chunk.

6. The storage equipment of claim 1, wherein the one or more metadata attributes comprise a first metadata attribute and a second metadata attribute, wherein the first metadata attribute and the second metadata attribute are different retention lock date values, and wherein, prior to the packing of the collection of packing objects into the storage chunk, the operations further comprise:
instantiating, based on the first metadata attribute, a first storage chunk of the defined chunk size;
instantiating, based on the second metadata attribute, a second storage chunk of the defined chunk size;
based on the different retention lock date values, separating the collection of packing objects into a first collection of packing objects and a second collection of packing objects; and
packing the first collection of packing objects into the first storage chunk of the defined chunk size, and packing the second collection of packing objects into the second storage chunk of the defined chunk size.

7. The storage equipment of claim 1, wherein the operations further comprise determining, based on the one or more metadata attributes, that the first object is associated with a first defined retention lock date value and the second object is associated with a second defined retention lock date value associated, and wherein the first defined retention lock date value and the second defined retention lock date value fall within a defined range of date values.

8. A method, comprising:
fetching, from cloud storage equipment by a device comprising at least one processor, a group of user identity generated objects associated with one or more metadata attributes;
based on the one or more metadata attributes, determining, by the device, a first object of the group of user identity generated objects and a second object of the group of user identity generated objects, a collection of packing objects to be included into a storage chunk of a defined chunk size;
packing, by the device, the collection of packing objects into the storage chunk;
creating, by the device, storage chunk metadata attributes;
associating, by the device, the storage chunk metadata attributes with the storage chunk of the defined chunk size; and
transferring, by the device, the storage chunk and the storage chunk metadata attributes to the cloud storage equipment.

9. The method of claim 8, wherein the one or more metadata attributes comprise a defined retention lock expiration date.

10. The method of claim 8, wherein the one or more metadata attributes comprise a unique identification tag associated with the first object, a creation time value associated with the first object, an object size value associated with the first object, or object type data associated with the first object data.

11. The method of claim 8, wherein at least one of the storage chunk metadata attributes is a first defined retention lock expiration date, wherein the first defined retention lock expiration date is determined based on a second defined retention expiration date that is associated with the one or more metadata attributes associated with the first object or the second object.

12. The method of claim 8, further comprising instantiating, by the device, the storage chunk of a defined chunk size prior to the packing of the collection of packing objects into the storage chunk.

13. The method of claim 8, wherein the one or more metadata attributes comprise a first metadata attribute and a second metadata attribute, wherein the first metadata attribute and the second metadata attribute are different retention lock date values, and wherein prior to the packing, by the device, of the collection of packing objects into the storage chunk, further comprising:
based on the first metadata attribute instantiating, by the device, a first storage chunk of the defined chunk size;
based on the second metadata attribute, instantiating, by the device, a second storage chunk of the defined chunk size;
based on the different retention lock date values, segregating, by the device, the collection of packing objects into a first collection of packing objects and a second collection of packing objects; and
packing, by the device, the first collection of packing objects into the first storage chunk of the defined chunk size, and packing, by the device, the second collection of packing objects into the second storage chunk of the defined chunk size.

14. The method of claim 8, further comprise determining, by the device based on the one or more metadata attributes, that the first object is associated with a first defined retention lock date value and the second object is associated with a second defined retention lock date value associated, wherein the first defined retention lock date value and the second defined retention lock date value fall within a defined range of date values.

15. A non-transitory machine-readable medium, comprising executable instructions that, when executed by a network device comprising at least one processor, facilitate performance of operations, comprising:
receiving, from cloud storage equipment, a group of user identity generated objects associated with at least one metadata attribute;
based on the at least one metadata attribute, determining a first object of the group of user identity generated objects and a second object of the group of user identity generated objects, a collection of packing objects to be included into a storage chunk of a defined chunk size;
packing the collection of packing objects into the storage chunk;
creating storage chunk metadata attributes;
associating the storage chunk metadata attributes with the storage chunk of the defined chunk size; and
transferring the storage chunk and the storage chunk metadata attributes to the cloud storage equipment.

16. The non-transitory machine-readable medium of claim 15, wherein the at least one metadata attribute comprises a defined retention lock expiration date.

17. The non-transitory machine-readable medium of claim 15, wherein at least one of the storage chunk metadata attributes is a first defined retention lock expiration date, and wherein the first defined retention lock expiration date is determined based on a second defined retention expiration date that is associated with the at least one metadata attribute associated with the first object or the second object.

18. The non-transitory machine-readable medium of claim 15, wherein the operations further comprise instantiating the storage chunk of a defined chunk size prior to the packing of the collection of packing objects into the storage chunk.

19. The non-transitory machine-readable medium of claim 15, wherein the at least one metadata attribute comprises a first metadata attribute and a second metadata attribute, wherein the first metadata attribute and the second metadata attribute are different retention lock date values, and wherein, prior to the packing of the collection of packing objects into the storage chunk, the operations further comprise:
based on the first metadata attribute instantiating a first storage chunk of the defined chunk size;
based on the second metadata attribute, instantiating a second storage chunk of the defined chunk size;
based on the different retention lock date values, segregating the collection of packing objects into a first collection of packing objects and a second collection of packing objects; and
packing the first collection of packing objects into the first storage chunk of the defined chunk size, and packing the second collection of packing objects into the second storage chunk of the defined chunk size.

20. The non-transitory machine-readable medium of claim 15, wherein the operations further comprise determining, based on the at least one metadata attribute, that the first object is associated with a first defined retention lock date value and the second object is associated with a second defined retention lock date value associated, and wherein the first defined retention lock date value and the second defined retention lock date value fall within a defined range of date values.
